(19) United States
(12) Patent Application Publication
(10) Pub. No.: US 2005/0169114 A1
(43) Pub. Date: Aug. 4, 2005

(54) Digital recorder for selectively storing only a music section out of radio broadcasting contents and method thereof

(76) Inventor: Hosung Ahn, Seoul (RU)

Correspondence Address: JONES DAY, 222 EAST 41ST ST, NEW YORK, NY, 10017, US

(21) Appl. No.: 10/504,701

(22) PCT Filed: Jan. 30, 2003
(86) PCT No.: PCT/KR03/00214

(30) Foreign Application Priority Data
Feb. 20, 2002 (KR) 10-2002-0009044

(51) Int. Cl. H04H 9/00

(52) U.S. Cl. 369/7

(57) ABSTRACT

The present invention relates to a method and apparatus for selectively and retroactively recording only a music section out of radio broadcast content. According to the present invention, there is provided a method for selectively and retroactively recording only a music section out of radio broadcast content, comprising the steps of (a) detecting a start point of the music section; (b) temporarily recording the music section from the start point in a buffer memory; (c) detecting a command to record the music section placed by a user; and (d) transferring the music section recorded in the buffer memory to a semi-permanent memory.

### FIELD OF THE INVENTION

The present invention relates to a digital recorder and a method for automatically selecting and storing music from radio broadcasting contents, and more particularly, to a digital recorder and a method for automatically extracting only music section from radio broadcasting contents and storing the selected music from beginning to end according to a user's recording selection.

### DESCRIPTION OF THE PRIOR ART

Recently, people who enjoy listening to music prefer to use digital recorders, which can reproduce a high quality of musical sound, rather than conventional analog recorders. As a device for reproducing a digital music file, a digital recorder is relatively small in size, because it contains a nonvolatile digital memory (media card) capable of reading and writing music data. Due to such an advantage, portable digital recorders, so-called “MP3 (MPEG Audio-Layer 3) players,” have rapidly become popular. Generally, MP3 players not only reproduce stored music data but also have a radio function to receive live FM radio music broadcasts.

FIG. 1 is a block diagram showing the configuration of a conventional MP3 player having a radio function.

The conventional MP3 player 100 comprises an antenna 110, a tuner 120, a sound output section 130, a DSP (digital signal processor) 140, an external device connecting section 150, a controller 160, a music data storing section 170, a display section 180 and a key operating section 190.

The antenna 110 receives sky-wave signals. The tuner 120 receives and outputs a radio signal corresponding to a tuned channel, among sky-wave signals received by the antenna 110. The sound output section 130 filters and amplifies an analog acoustic signal received from the tuner 120 in order to output the signal as an audible sound. The DSP 140 converts an analog acoustic signal received from the tuner 120 into digital data or digital music data into an analog acoustic signal, and outputs the converted signal or data. Also, the DSP 140 decodes and converts encoded music data into an analog acoustic signal and outputs the signal. The external device connecting section 150 is connected to an external device (e.g., a computer) in order to download MP3 music data. The controller 160 controls the storage and output of MP3 music data, as well as the receiving and output of a radio broadcasting signal. The music data storing section 170 is a storage medium in the form of a flash memory or a hard disk for storing multiple music data compressed in MP3. If the music data storing section 170 has a capacity of 64 Mbytes or 128 Mbytes, it can store about 16 or 32 songs of MP3 music files. The display section 180 displays the operational state of the MP3 player. The key operating section 190 performs an input operation for selecting a radio broadcasting channel or for selecting and outputting a MP3 music file.

If a user wishes to listen to music through the MP3 player 100, he or she can select a radio function to listen to music in real time in a desired music broadcasting channel. Alternatively, the user can select music data stored in the music data storing section 170 to listen to desired music.

Particularly, while listing to an FM radio music broadcast by selecting the radio function, the user can record the music, which is being currently broadcasted on radio, by pressing a record button (not shown) provided in the key operating section 190. Then, the controller 160 controls the DSP 130 to convert a music signal outputted from the tuner 120 into digital data, and stores the digital data in the music data storing section 170. If the user presses the record button again when the music ends, the recording operation will be stopped. The user should pay close attention to correctly recognize the beginning and end of the music.

If a radio channel streams music after an introduction to the music, users will have time to prepare before recording the music. However, in most cases, users decide to record music after hearing the beginning of the music on the radio. In other words, live music received from a radio station, excluding the beginning part thereof, can be stored in the music data storing section 107. When reproducing the music after completion of the recording operation, the users can only hear the part recorded after some lapse of time. Therefore, in conventional MP3 players 100, an additional function has been demanded to record and reproduce music broadcasted on radio from the beginning thereof, even in a case in which a user starts to record the music after some lapse of time.

### SUMMARY OF THE INVENTION

Accordingly, the present invention has been made to solve the above-mentioned problems occurring in the prior art, and an object of the present invention is to provide a digital recorder and a method for automatically selecting music from radio broadcasting contents to enable a user to record and reproduce music broadcasted on radio from the beginning thereof at any time according to the user's selection.

In order to accomplish this object, there is provided a digital recorder which selects a music signal from broadcasting signals and store the selected signal as music data, and which includes a tuner for receiving and selecting broadcasting signals, a sound output section for outputting a selected broadcasting signal as an audible sound, a music data storing section comprising a temporary storage area for temporarily storing music data and a permanent storage area for storing music data permanently or for a long-term, and a display section for displaying the operational state of the digital recorder, improvements of which comprise: a signal processing section for converting a broadcasting signal into digital data or digital data into an analog signal, compressing and encoding digital data into music data, or decoding and outputting compressed digital data; a music extracting section for dividing digital data outputted from the signal processing section into music data and non-music data according to a music extracting algorithm to extract only the music data, and generating and outputting beginning/end data for recognizing the beginning and end of the extracted music data; a key input section provided with a broadcast key for converting the operation mode of the digital recorder into a radio broadcast receiving mode and a record key for implementing a function to record and store a music signal broadcasted on radio; and a microprocessor for controlling the signal processing section to temporarily store only the music data extracted by the music extracting section in the temporary storage area of the music data storing section, transferring the music data temporarily stored in the temporary storage area to the definite storage area when the record key is pressed, and definitely storing and maintaining the music data in the definite storage area.

In order to accomplish the above object, there is also provided a method for selectively storing music using a digital recorder comprising: a tuner for receiving and selecting a broadcasting signal; a sound output section for outputting a selected broadcasting signal as an audible sound; a digital signal processor (DSP) for converting a broadcasting signal into digital data or digital data into an analog signal, compressing and encoding digital data into music data, or decoding and outputting compressed digital data; a music extracting section for extracting only music data from the digital data received from the DSP; a music data storing section for storing music data; a display section for displaying the operational state of the digital recorder; and a key input section for converting the operation mode of the digital recorder into a radio broadcast receiving mode and inputting a command to implement the recording of a music signal broadcasted on radio, said method comprising the steps of: (a) said tuner's outputting a broadcasting signal to the sound output section and sending the signal to the DSP; (b) said DSP's converting the broadcasting signal into digital data and outputting the data to the music extracting section; (c) said music extracting section's extracting music data from the digital data according to a music extracting algorithm; (d) recognizing the beginning and end of the extracted music data and temporarily storing the data in the music data storing section; (e) determining whether a command to record music, which is being currently outputted to the sound output section, is inputted from the key input section; and (f) definitely storing and maintaining the music data which is temporarily stored in the music data storing section.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing the configuration of a conventional MP3 player having a radio function;

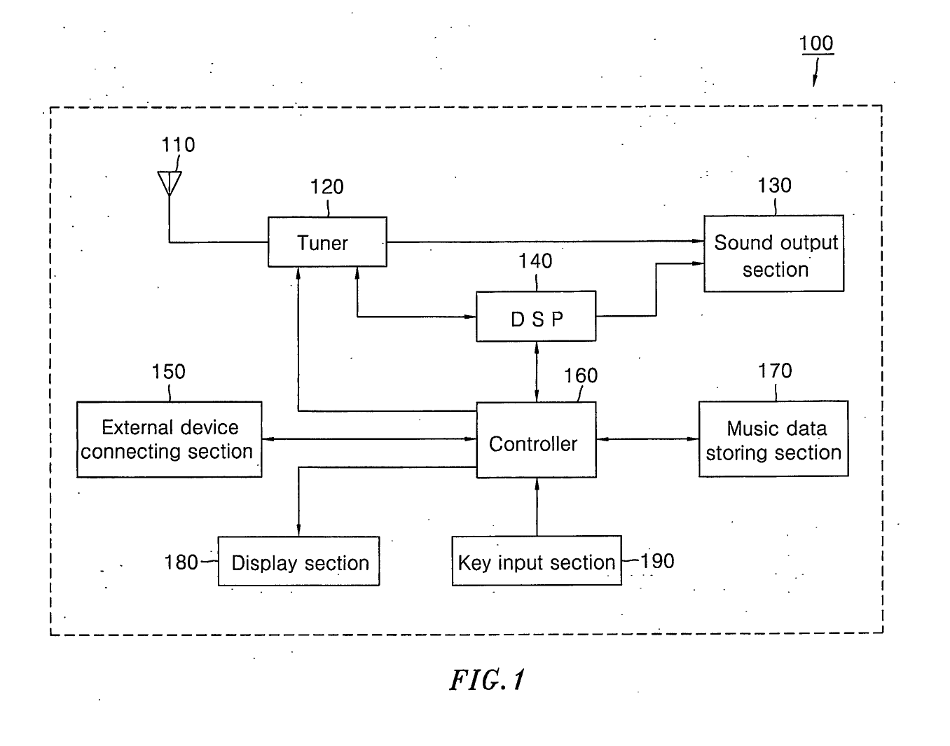

FIG. 2 is a block diagram showing the configuration of a digital recorder for selectively storing music according to the present invention;

FIG. 3 is a block diagram showing the inner configuration of a music extracting section comprising an artificial neural network according to a first embodiment of the present invention;

FIG. 4 is a flow chart showing a process of automatically selecting and storing music using an artificial neural network according to the first embodiment of the present invention;

FIG. 5 is a block diagram showing the inner configuration of a music extracting section utilizing a frequency analysis according to a second embodiment of the present invention;

FIG. 6 shows the constituents of a music signal, including a mute;

FIG. 7 is a flow chart showing a process of automatically selecting and storing music using a frequency analysis according to the second embodiment of the present invention;

FIG. 8 is a block diagram showing the inner configuration of a music extracting section utilizing an HMM (hidden Markov model) according to a third embodiment of the present invention;

FIG. 9 shows the principle of Viterbi algorithm for finding the most likely state sequence with the maximum probability; and

FIG. 10 is a flow chart showing a process of automatically selecting and storing music utilizing an HMM according to the third embodiment of the present invention.

### DETAILED DESCRIPTION OF THE INVENTION

Hereinafter, preferred embodiments of the present invention will be described with reference to the accompanying drawings. In the following description and drawings, the same reference numerals are used to designate the same or similar components. Therefore, repetition of the description on the same or similar components will be omitted.

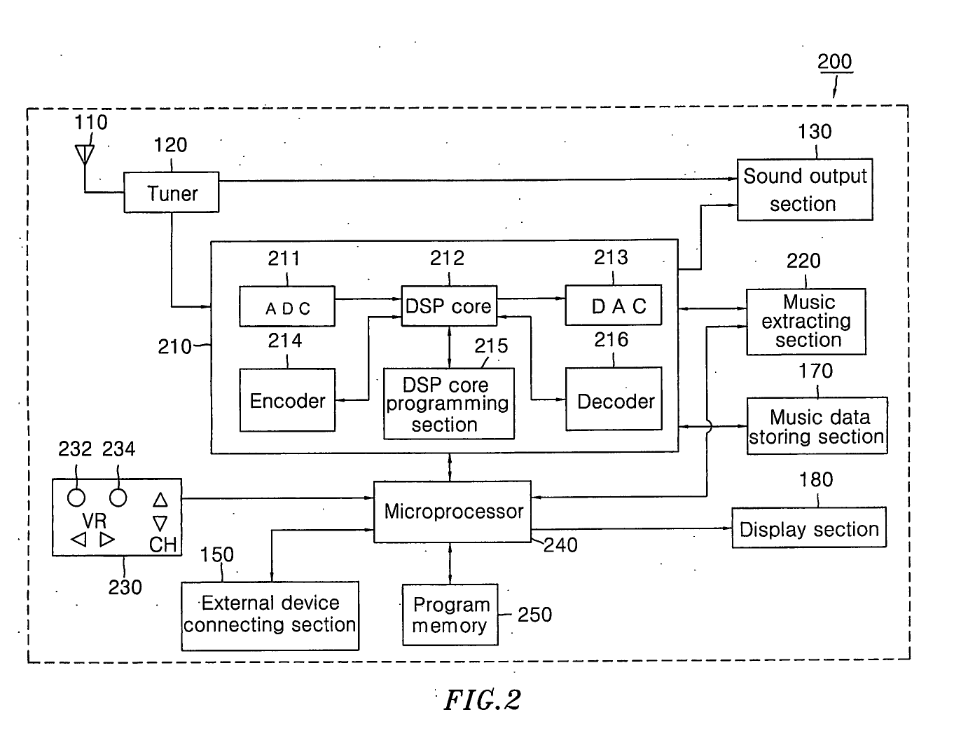

FIG. 2 is a block diagram showing the configuration of a digital recorder for selectively storing music according to the preferred embodiments of the present inventions.

Referring to FIG. 2, the digital recorder 200 comprises a DSP 210, a music extracting section 220, a key input section 230, a microprocessor 240 and a program memory 250.

The DSP 210 includes: an ADC (analog to digital converter) 211 for converting an analog signal into a digital signal; a DSP core 212 for controlling the overall operation of the DSP 210; a DAC (digital to analog converter) 213 for converting a digital signal into an analog signal; an encoder 214 for compressing and encoding an analog signal, for example, into MP3 file data; a DSP program section 215 storing a program for converting a broadcasting signal received from a tuner 120 into digital data according to a control command from the microprocessor 240, compressing and encoding the digital data, and decoding and outputting the compressed digital data; and a decoder 216 for decoding the compressed digital data. Of course, the digital recorder can include a hardware-based signal processing section, instead of the DSP 210.

The music extracting section 220 divides a digital signal received from the DSP 210 into music data and non-music data according to its own music extracting algorithm in order to extract the music data, while removing the non-music data. To perform this extracting function, the music extracting section 220 utilizes an artificial neural network, a frequency analysis or an HMM (hidden Markov model).

The key input section 230 includes a broadcast key 232 for converting the operation mode of the digital recorder into a radio broadcast receiving mode and a record key 234 for implementing a function to record and store a music signal which is being broadcasted on radio, as well as a channel key for selecting a channel and a volume key for adjusting the volume of an acoustic output.

When the digital recorder is in a broadcast receiving mode, the DSP 210 and the music extracting section 220 divide broadcasting signals received by the tuner 120 into music data and non-music data to extract only the music data. The music data is temporarily stored in the music data storing section 170. When the record key 234 provided in the key input section 230 is pressed, the music data currently being outputted and temporarily stored is definitely stored from the beginning thereof in the music data storing section 170. The microprocessor 240 controls the overall process of storing the music data.

The music data storing section 170 has a temporary storage area for temporarily storing music data and a definite storage area for definitely storing music data according to a command to definitely record and store the music data. The temporary storage area can store music data of an amount close to one song. When the record key 234 is pressed for a particular music, the microprocessor 240 transfers the music data stored in the temporary storage area to the definite storage area in order to definitely store the music data.

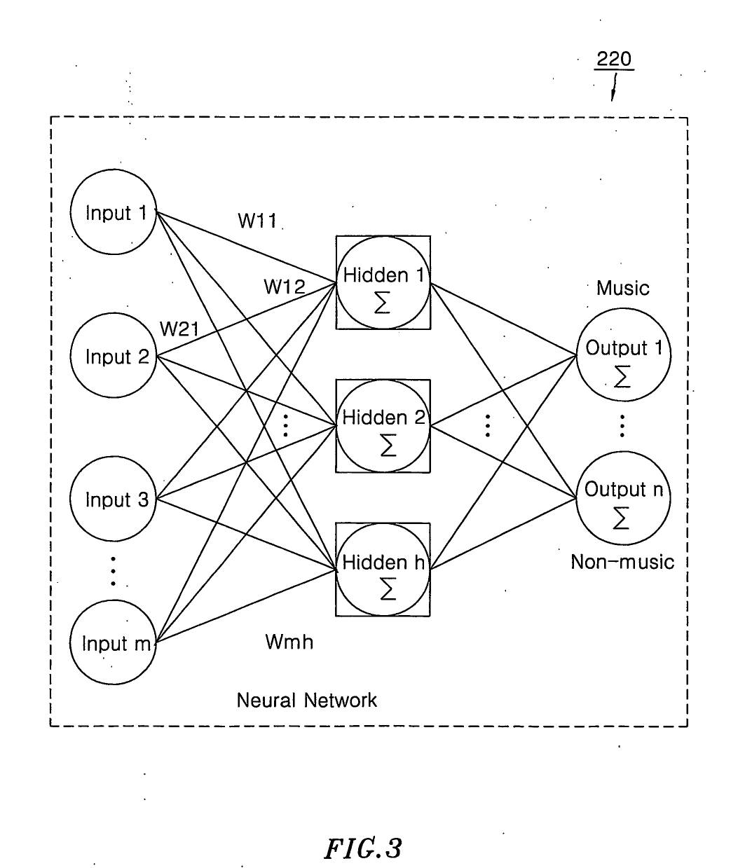

FIG. 3 is a block diagram showing the inner configuration of the music extracting section 220 including an artificial neural network according to the first embodiment of the present invention.

The music extracting section 220 according to the first embodiment extracts only music data from broadcasting signals received at the currently tuned channel according to a music extracting algorithm utilizing an artificial neural network. When large amounts of acoustic signals included in broadcasting signals are inputted, the music extracting algorithm utilizing an artificial neural network implements an operation on the inputted signals. The music extracting algorithm reduces the dimension of input data to divide them into music signals and non-music signals, and removes the non-music signals to output only the music signals.

To improve understanding of the first embodiment of the present invention, “artificial neural networks” will be explained in more detail.

The “artificial neural networks” are computation systems modeled after the structure of the human or animal brain. Neurons in the brain, being in highly complex connections, interact with each other to process information in a parallel and distributed fashion. The artificial neural networks are patterned after biological neurons. Every artificial neural network forms a neural network using threshold logic units having critical values and applies a learning algorithm for adapting the given neural network to the environment such as data.

Various neural network models are available according to the architectures of forming neural networks. The most generally used model is a multilayer perceptron architecture, wherein neurons are grouped into layers, including a layer of input neurons, a layer of output neurons and an intermediate layer of hidden neurons (or hidden nodes) as shown in FIG. 3. While there is no link between neurons on the same layer, each neuron on a layer other than the output layer is connected to every neuron on the next layer. The neurons on the first layer send their output in the direction of the neurons on the second layer, which is termed “feed-forward.” A weight Wmh is given on each connection between neurons, and a weighed input is summed up at the next layer. The neural network learns to recognize the weight. As a weight learning algorithm, “error backpropagation” is generally adopted. In the present invention, the multilayer perceptron architecture is used as an artificial neural network. Also, such a single hidden layer, feed-forward neural network and error backpropagation learning algorithm are used in the present invention.

According to the first embodiment of the present invention, the music extracting section 220 utilizes an artificial neural network trained with patterns of frequencies and having the multilayer perceptron architecture. It is important to appropriately adjust training parameters, such as epoch (one pass over all patterns in the training set) and the number of hidden nodes, when training the neural network. The music extracting section 220 divides broadcasting signals into music signals and non-music signals to extract the music signals only, while removing the non-music signals.

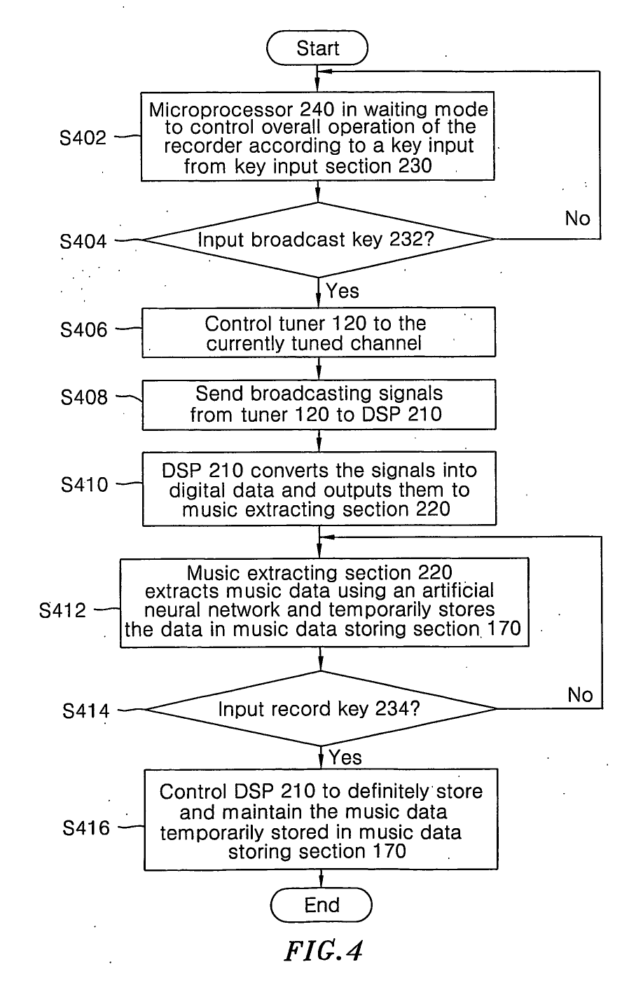

Hereinafter, the operation of the digital recorder, which extracts music data using an artificial neural network, will be explained in further detail with reference to FIG. 4.

FIG. 4 is a flow chart showing a process of automatically selecting and storing music using an artificial neural network according to the first embodiment of the present invention.

When the digital recorder 200 is powered and the microprocessor 240 is in a waiting mode for controlling the overall operation of the recorder according to a key input at the key input section 230 (S402), a user can press the broadcast key 232 provided in the key input section 230 to listen to the radio. When the broadcast key 232 is pressed (S404), the microprocessor 240 controls the tuner 120 to receive broadcasting signals of a currently tuned channel. The microprocessor 240 also controls the DSP 210 to encode the received broadcasting signals and converts them into digital data. Of course, the user can select another channel by operating the channel key provided in the key input section 230. The microprocessor 240 remembers the channel tuned by the key input section 230. Unless the user selects another channel using the key input section 230, the microprocessor 240 controls the tuner 120 to receive the broadcasting signals of the tuned channel. If the user selects another channel, the microprocessor 240 will then control the tuner 120 to receive broadcasting signals of the other channel (S406).

The broadcasting signals are received by the tuner 120. The tuner 120 outputs the broadcasting signals of the tuned channel to the sound output section 130 and to the DSP 210 simultaneously. The sound output section 130 outputs the analog broadcasting signals received from the tuner 120 as an audible sound. The DSP core 212 of the DSP 210 converts the broadcasting signals received from the tuner 120 into digital data using the ADC 211. Also, the encoder 214 encodes the digital data to music file data and temporarily stores the data in the music data storing section 170. While the user is listening to the voice and music broadcasted over the radio, the digital recorder 200 extracts only music signals from the broadcasting signals and temporarily stores the extracted music signals. If the user inputs a command to record music, the digital recorder 200 definitely stores the music which is being currently broadcasted on radio.

Broadcasting signals received by the digital recorder 200 have various segments, such as a music segment for broadcasting music, a commercial break segment for commercial messages and a speech segment for transferring the voice of a radio DJ (disk jockey) or a radio cast. The broadcasting signals received by the antenna 110 are transmitted to the tuner 120. The tuner 120 outputs the broadcasting signals of the currently tuned channel to the DSP 210 (S408). The DSP 210 outputs the broadcasting signals to the sound output section 130 via the ADC 211, the DSP core 212 and the DAC 213. At the same time, the DSP 210 encodes music signals included in the broadcasting signals into digital music data, for example, MP3 music data, using the encoder 214 and outputs the encoded data to the music extracting section 220 (S410).

As shown in FIG. 3, the music extracting section 220 receives the broadcasting signals outputted from the DSP 210 as an input, and divides the signals into music data and non-music data according to a predetermined music extracting algorithm using an artificial neural network. The music extracting section 220 removes the non-music data and temporarily stores only the music data in the music data storing section (S412). The microprocessor 240 controls the DSP 210 to store music, which is being currently outputted to the sound output section 130, in the temporary storage area of the music data storing section 170. When a record command is inputted from the key input section 230, the microprocessor 240 controls the DSP 210 to store and maintain the music data, which is temporarily stored in the music data storing section 170, retroactively from the beginning of the music data.

If the user wishes to record music which is being currently outputted to the sound output section 130, he or she should press the record key 234 of the key input section 230. When the record key 234 is pressed (S414), the microprocessor 240 controls the DSP 140 to transfer the music data, which is temporarily stored in the temporary storage area of the music data storing section 170, to the definite storage area in order to definitely store and maintain the music data (S416).

The music data storing section 170 stores music data in the order they are received. If the record key 234 is not pressed, music data will be continuously stored in the music data storing section 170 by the music extracting section 220. If the music data exceed the storage capacity of the music data storing section 170 (that is, if new music data is received to be stored in the full music data storing section 170), the DSP 210 will delete the music data one by one in the order they were stored, in order to store the new music data.

The key input section 230 includes a key with a function to delete music data. The key input section 230 outputs a list of the music data stored in the music data storing section 170 to the display section 180. The user can delete any selected music data by pressing the delete key.

According to the first embodiment of the present invention, the digital recorder 200 can output received broadcasting signals as an audible sound. Also, the digital recorder 200 can select only music signals from the received broadcasting signals and store the music signals as digital music data.

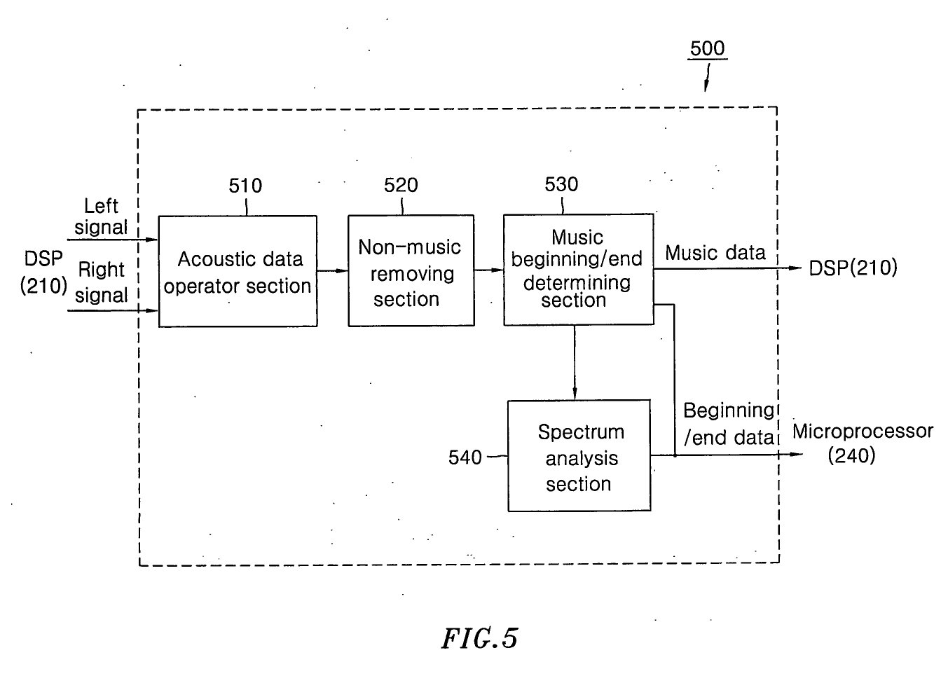

FIG. 5 is a block diagram showing the inner configuration of a music extracting section 500 utilizing a frequency analysis according to the second embodiment of the present invention.

Generally, radio is broadcasted in either monophonic (mono) or stereophonic (stereo) sound.

The mono mode is to broadcast acoustic signals using a single frequency channel. Since the mono mode outputs sound received by a sound receiving means disposed at a place regardless of the sound source, the acoustic signals outputted through a mono audio system may be slightly different from the original acoustic signals. By contrast, the stereo mode is to broadcast acoustic signals using a plurality of frequency bandwidths. The stereo mode divides an acoustic signal into a left stereo signal and a right stereo signal according to the sound source, and transfers each of the left and right stereo signals to a plurality of frequency bandwidths. When compared to the mono mode, the stereo mode gives greater realism because it outputs acoustic signals which are closer to the original sound.

Sounds broadcasted by radio are generally classified into four segments, i.e., a radio cast's speech segment, a music and cast's speech coexisting segment, a commercial break segment and a music segment. The speech segment is closer to mono signals, while the other segments are closer to stereo signals. A stereo broadcasting signal has a slight difference between the information of the left channel and that of the right channel. The phase values of the sound waveforms in the two channels with lapse of time can be compared to each other in order to determine whether the phase values of the two channels are identical. If there is no phase difference, the broadcasting signal will be determined to be monophonic. If monophonic speech signals are removed, it will be possible to obtain music signals which are mostly stereo signals.

Referring to FIG. 5, the music extracting section 500 according to the second embodiment of the present invention analyzes broadcasting signals and divides them into mono signals and stereo signals. The music extracting section 500 removes the mono signals to obtain the stereo signals only. In other words, broadcasting signals including mono signals are shown on the time axis. A volume difference between the left and right channels of the broadcasting signals is calculated on the time axis. When the volume difference is near zero, the broadcasting signals are determined to be monophonic. When a volume difference greater than any critical value lasts for a certain period of time, the signals are determined to be stereophonic. Accordingly, the mono signals are removed to obtain the stereo signals only.

The music extracting section 500, which utilizes a frequency analysis according to the second embodiment of the present invention, includes an acoustic data operator section 510, a non-music removing section 520, a music beginning/end determining section 530 an a spectrum analysis section 540.

The acoustic data operator section 510 implements operations on the left channel data and right channel data of the broadcasting data received from the DSP 210 and outputs data on the operation results. When the results are near zero, the broadcasting data are determined to be mono data. When the results show that a value greater than a critical value lasts for a certain period of time, the broadcasting data are determined to be stereo data. Based on the operation results, the mono data is removed to obtain only the stereo data.

The music beginning/end determining section 530 outputs the music data received from the non-music removing section 520 to the DSP 210. Also, the music beginning/end determining section 530 generates beginning/end data for discriminating and recognizing the beginning and end points of the music data and transfers the beginning/end data to the microprocessor 240. For this transfer, a separate output port is provided. In addition, the music beginning/end determining section 530 sends the received music data to the spectrum analysis section 540, when it fails to discriminate the beginning part of new music data from the end part of previous music data because there is no mute between the two music data or there is an overlapping part between the two music data. The spectrum analysis section 540 performs a spectrum analysis on the music data received from the music beginning/end determining section 530 to discriminate between the beginning and ending g signals of music, and sends beginning/end data for recognizing the beginning and end signals to the microprocessor 240.

In order to discriminate between the beginning and end parts of music, the digital recorder 200 of the present invention detects a fade-out at the end part of music data. Most music broadcasted on radio are faded out at their ending parts. According to the second embodiment of the present invention, the music beginning/end determining section 530 of the music extracting section 500 detects the fade-out in each music data, thereby discriminating the beginning of the following music from the end of the previous music.

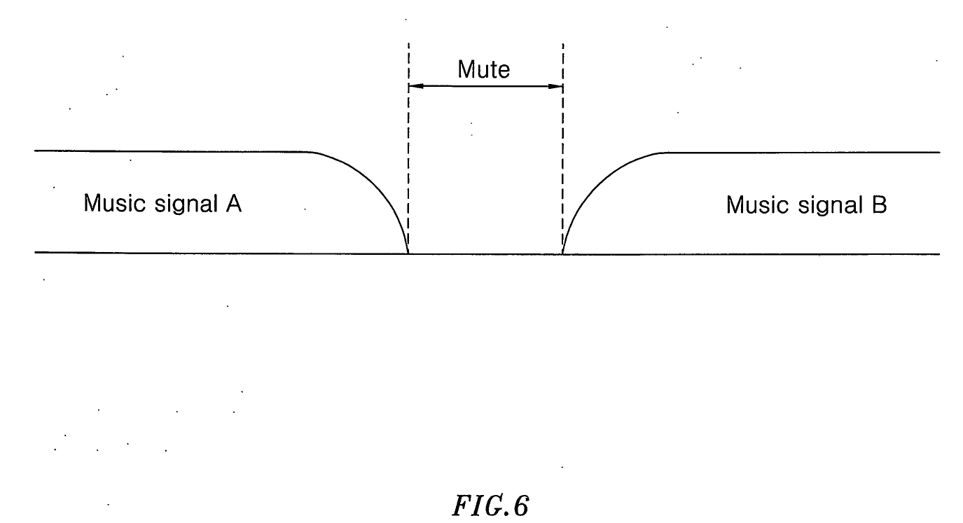

As shown in FIG. 6, there may be a mute between a previous music signal A and a following music signal B. When there is a mute after output of a music signal A, the music beginning/end determining section 530 determines that the music signal A ends. When a music signal B follows the mute, the music beginning/end determining section 530 determines that the music signal B begins. The music beginning/end determining section 530 generates beginning/end data based on such determination and outputs the data to the microprocessor 240.

Generally, a frequency signal has a greater energy value at a point where a speech or music signal is present. On this basis, the music beginning/end determining section 530 calculates an energy variation. The music beginning/end determining section 530 recognizes a lower energy point as a mute or a probable ending point of music. The energy value is obtained by squaring the phase value of the music data in frames, which is received from the non-music removing section 520, and taking the log of the squared value.

In most music genres other than classical music, a single music signal has a length of about three to five minutes. When the beginning and end points of music are determined only by the presence of a mute, it is likely that a mute in the middle of music may be erroneously recognized as the beginning or end point of music. In order to reduce the error rate in determining the beginning and end points of music, the music beginning/end determining section 530 detects and determines the beginning and end points of the music, taking into account that the average length of a single music signal is three to five minutes.

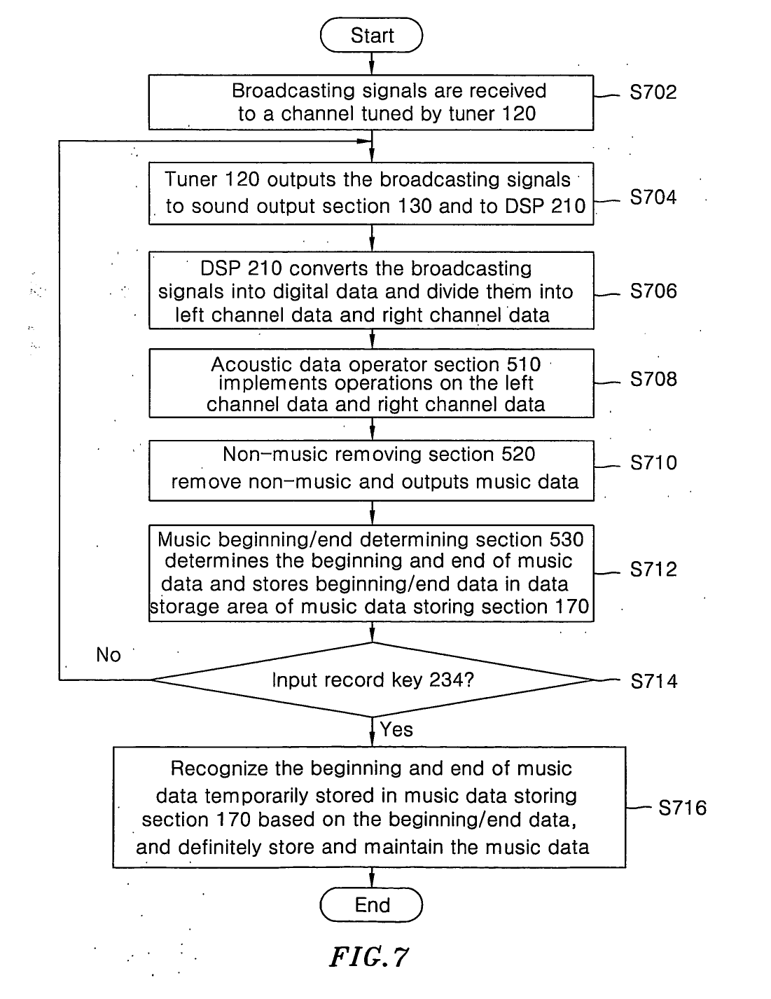

Hereinafter, the operation of the digital recorder, which includes the music extracting section 500 utilizing a frequency analysis, will be explained in further detail with reference to FIG. 7.

FIG. 7 is a flow chart showing a process of selectively storing music utilizing a frequency analysis according to the second embodiment of the present invention.

The digital recorder 200 has both functions of reproducing stored music data and receiving radio broadcasts in real time. When the user sets the digital recorder 200 in a broadcast receiving mode by pressing the broadcast key 232 provided in the key input section 230, the microprocessor 240 controls the tuner 120 to receive broadcasting signals at the tuned channel (S702).

The tuner 120 outputs the broadcasting signals received by the antenna 110 to the sound output section 130 and at the same time sends the broadcasting signals to the DSP 210 (S704) in order to extract music signals from the broadcasting signals in preparation for storing music data, while enabling the user to hear the broadcast. In the DSP 210, the broadcasting signals are converted into digital data by the ADC 211. The DSP core 212 divides the digital music data into left channel data and right channel data and sends the divided data to the music extracting section 220. The left and right channel music data outputted from the DSP 210 are transferred to the acoustic data operator section 510 of the music extracting section 220. The acoustic data operator section 510 implements an operation on the left channel data and right channel data received from the DSP 210 and outputs the operation results (S708). When the results are near “0”, the data are recognized as mono data. When the results show that a value greater than a critical value lasts for a certain period of time, the data are recognized as stereo data.

Based on the operation results received from the acoustic data operator section 520, the non-music removing section 520 removes the mono speech data and outputs only the stereo music data to the music beginning/end determining section 530 (S710). The music beginning/end determining section 530 determines the beginning and end points of the music data received from the non-music removing section 520, based on (1) the fade-out in the music data, (2) the presence of a mute in the music data, or (3) the average length (3 to 5 minutes) of single music data. (4) When there is an overlapping part between previous music data and following music data, the music beginning/end determining section 530 outputs the music data to the spectrum analysis section 540 to perform a spectrum analysis on the music data and discriminate between the beginning and ending points of music. Lastly, (5) the beginning and end points of music can be determined based on the energy value obtained by squaring the phase value of the music data in frames and taking the log of the squared value. The beginning and end points of music data are determined based on a combination of the five factors or processes. The music beginning/end determining section 530 generates beginning/end data informing the beginning and end points of the music data and transfers the beginning/end data to the microprocessor 240. The microprocessor 240 stores the beginning/end data in a non-music storage area of the music data storing section 170 (S712). The music beginning/end determining section 530 not only generates the beginning/end data but also outputs the music data to the DSP 210. The DSP 210 encodes the music data, which is being outputted, and stores it in the temporary storage area of the music data storing section 170 in preparation for recording the music that the user is currently hearing on the radio.

When the user presses the record key 234 provided in the key input section 230 in order to record the music currently broadcasted on radio (S714), the microprocessor 240 reads the beginning/end data of the music, which is being currently outputted, from the non-music storage area of the music data storing section 170. Based on this beginning/end data, the microprocessor 240 recognizes the beginning and end of the music data temporarily stored in the temporary storage area of the music data storing section 170b and transfers the music data to the definite storage area to definitely store and maintain the music data (S716).

The temporary storage area of the music data storing section 170 is capable of storing music data amounting to about one song. The temporary storage area temporarily stores the music data sent to the DSP 210. When new music data is received without an input of the record key 234, the temporary storage area deletes the previously stored music data in order to temporarily store the new music data. As explained in the first embodiment, “definitely store and maintain” means that the music data temporarily stored in the temporary storage area of the music data storing section 170 is transferred to the definite storage area so that the storage of the music data can be definitely maintained. Of course, the user can selectively delete any music data stored in the definite storage area using the key input section 230.

The definite storage area of the music data storing section 170 is capable of storing music data amounting to about six songs. If the record key 234 is pressed to store new music data while the music data storing section 170 is full, the microprocessor 240 outputs a message informing the full storage state to the display section 180, for example, “No more music can be stored. Will previously stored music be deleted?”, and waits for a key input from the key input section 230. If there is a key input to delete, the microprocessor 240 outputs a list of music data stored in the definite storage area of the music data storing section 170 to the display section 180 so that the user can select music to be deleted by placing an indication bar on the music data in the list. If the user presses a delete key, the music data selected by the indication bar will be deleted from the definite storage area. Also, the new music data stored in the temporary storage area will be transferred to the definite storage area to be definitely stored and maintained.

If the user does not press the record key 234 at step S714, the microprocessor 240 will return to step S704 to output the broadcasting signals to the sound output section 130 and control the DSP 210 to store music data, of which the beginning and end points are recognized and extracted by the music extracting section 500, in the temporary storage area of the music data storing section 170.

According to the second embodiment of the present invention, the digital recorder 200 comprises the music extracting section 500 utilizing a frequency analysis. The digital recorder 200 separates music signals from received broadcasting signals and recognizes the beginning and end of the music, which is being outputted, by a frequency analysis to store the music data. Accordingly, even in case when a user starts to record music after some lapse of time, the music can be recorded and reproduced from the beginning point thereof.

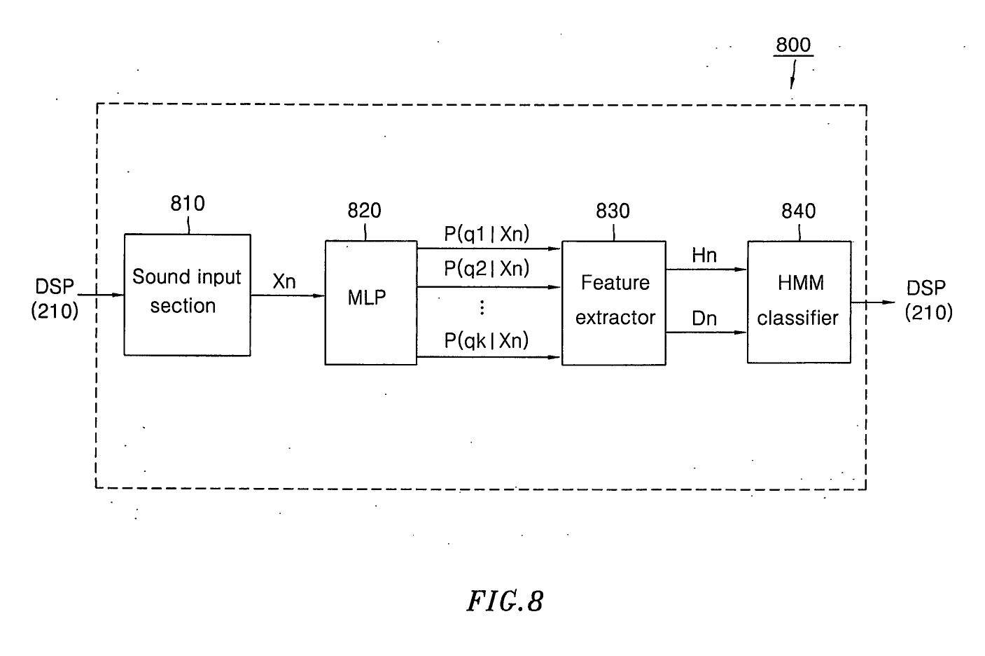

FIG. 8 is a block diagram showing the inner configuration of a music extracting section 800 utilizing an HMM (hidden Markov model) according to the third embodiment of the present invention.

In the third embodiment, the music extracting section 800 receives a mixed signal of a plurality of sound sources included in broadcasting signals as an input and retrieves signals of the independent sound sources. The music extracting section 800 collects data for extracting general human speech characteristics and utilizes a hidden Markov model (HMM) trained for such data to extract and remove speech signals. In other words, a hidden Markov model is used to obtain hidden speech information from mixed sound information. The hidden speech information is a Markov process. Under Markov assumption, “any state of a model is dependent only on the state that directly preceded it.” The Markov process refers to a process where transition between states is dependent only on the previous “n” states. The model is termed a n-dimensional model. “n” refers to the number of states that influence the next state.

An HMM consists of a transition probability for modeling a change of voice with time and an output probability for modeling a spectrum change. The HMM evaluates the similarity between models based on a stochastic estimate of the similarity with a given model, rather than the similarity of an input pattern with a reference pattern. The Viterbi algorithm is utilized to find the most likely sequence of hidden states that preprocess inputted speech data and generate an output similar to the corresponding input.

Estimation of probabilities is a complicated work because hidden states should be considered. In order to find the best state sequence that most properly explains data, it is required to set a standard for determining the “best”. The estimation of probabilities is associated with training and can be solved by the forward algorithm and the backward algorithm. Generally, the best state sequence is determined using the Viterbi algorithm, which is a dynamic programming method. Also, the Baum-Welch algorithm is applied to estimate parameters of an HMM.

The music extracting section 800 according to the third embodiment of the present invention extracts acoustic signals and their features utilizing the Baum-Welch algorithm for the estimation of parameters of an HMM. Also, the music extracting section 800 extracts only music signals utilizing the Viterbi algorithm.

As shown in FIG. 8, the music extracting section 800 comprises a sound input section 810, an MLP (multi-layer perceptron) 820, a feature extractor 830 and an HMM classifier 840.

The sound input section 810 inputs an audio signal including a plurality of acoustic signals, among broadcasting signals received from the DSP 210, and extracts the acoustic features of the audio signal, for example, zero-crossing information, energy, pitch, spectral frequency and cepstral coefficient. The sound input section 810 divides the audio signal into frames. Each frame has a length of about 10 ms to 30 ms and a different feature value. The frames are laid out in time sequence. The features extracted from the frames are denoted by “Xn”.

The MLP 820 adopts the algorithm used in the neural network speech recognition as explained in the first embodiment. The MLP 820 obtains a posterior probability showing the possibility (probability P) as to which phoneme “Xn” received from the sound input section 810 belongs to. If an inputted audio signal falls into a speech segment, there is a high probability that the signal is a particular phoneme. Phonemes are outputted to the output terminal of the MLP 820 in the number of k based on P(q1|Xn) per Xn, wherein q1˜qk represents the number of phonemes and Xn represents an acoustic feature obtained by the frame analysis at the sound input section 810.

The feature extractor 830 implements an operation based on the posterior probability received from the MLP 820 to obtain an entropy Hn which shows a probability distribution within a frame and a dynamism Dn which is a probability of a variation between frames. The feature extractor 830 outputs the entropy and dynamism features to the HMM classifier 840. If an audio signal is speech, the entropy will be near zero, while the dynamism will be high because of the large variation between frames. On the contrary, if the signal is music, it will have a high entropy because of the wide probability distribution and a low dynamism because of the less variation with time.

Following equations 1 and 2 are for obtaining entropy Hn and dynamism Dn, respectively.

$$\begin{matrix}{H}_{n} = - \frac{1}{N} {{Q}_{m = n - \frac{N}{2}}}^{n + \frac{N}{2}} {{Q}^{K}}_{k = 1} P ( {q}_{k} \vert {χ}_{m} ) {log}_{2} P ( {q}_{k} \vert {χ}_{m} ) & [ Equation 1 ] \\ {D}_{n} = - \frac{1}{N} {{Q}_{m = n - \frac{N}{2}}}^{n + \frac{N}{2}} {{{Q}^{K}}_{k = 1} [ P ( {q}_{k} \vert {χ}_{m} ) - P ( {q}_{k} \vert {χ}_{m + 1} ) ]}^{2} & [ Equation 2 ]\end{matrix}$$

The HMM classifier 840 classifies audio signals into a speech class and a music class based on the entropy Hn and dynamism Dn received from the feature extractor 830, utilizing the Baum-Welch algorithm and the Viterbi algorithm. The states in each class are all the same but present in a plural number. The HMM classifier 840 learns an HMM to optimize the probability of transition between states based on the two feature parameters (Hn, Dn) utilizing the Baum-Welch algorithm. The initial value before learning is set to a predetermined value. Actually, the HMM classifier 840 forms a table based on the received feature parameters and the learned HMM, when classifying audio signals into a speech class and a music class. Also, the HMM classifier 840 calculates the class to which an inputted audio signal belongs, using the Viterbi algorithm, and finally determines whether the signal belongs to a speech class or a music class.

The Baum-Welch algorithm and the Viterbi algorithm, both of which are utilized by the HMM classifier 840, will be explained in more detail.

After selecting a suitable model that best matches an observation sequence, it is required to determine the best state sequence of the model that generates the observation sequence. Generally, the Viterbi algorithm, which is a dynamic programming algorithm, is used to determine the best state of a model.

1. The Viterbi Algorithm

Given an observation sequence o and a model λ, the Viterbi algorithm is the most efficient method to determine a state sequence Q which generates the observation sequence o with the maximum probability. The probability of generating an observation sequence based on the observation sequence o and the model λ is P(q1, q2, . . . qT|o, λ).

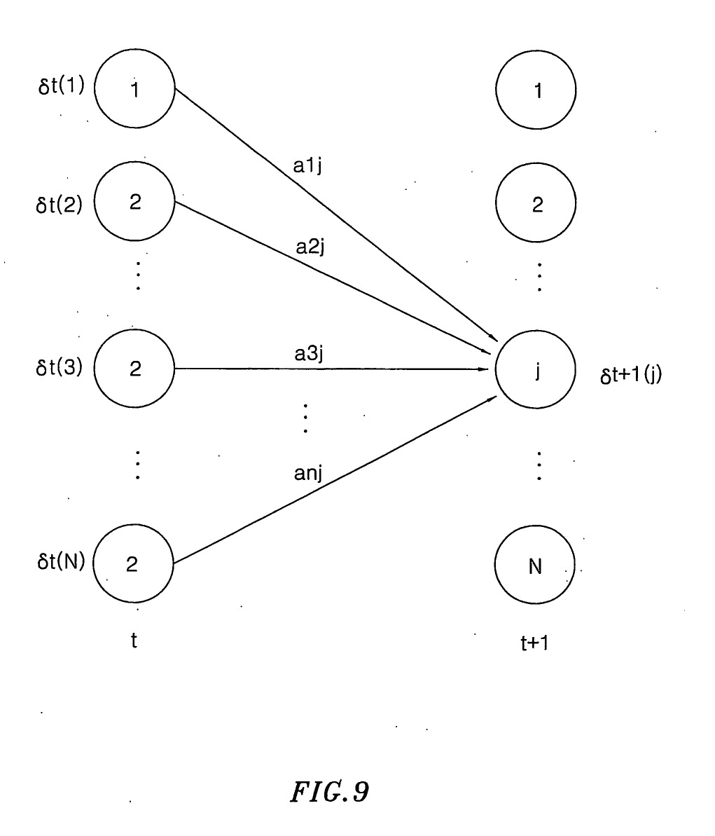

FIG. 9 shows the principle of the Viterbi algorithm for finding the most likely state sequence with the maximum probability.

In other words, FIG. 9 shows steps for determining the sequence of states that transit with the highest probability, among the state transitions from time t to time t+1. The Viterbi algorithm computes the state path with the maximum probability through the following steps:

| | |
|---|---|
| \hat{1} Initialization: | δ₁(i) = σᵢbᵢ(o₁), 1DiDN, ψ₁(i) = 0 |
| \hat{2} Recursion: | ${δ}_{1} ( j ) = \begin{matrix}max \\ 1 DiDn\end{matrix} [ {δ}_{t - 1} ( i ) {a}_{ij} ] {b}_{j} ( {o}_{t} ) 2 DtDT$ |
| | ${ψ}_{1} ( j ) = \begin{matrix}arg max \\ 1 DiDn\end{matrix} [ {δ}_{t - 1} ( i ) {a}_{ij} ] , 1 DjDN$ |
| \hat{3} Termination: | ${P}^{*} = \begin{matrix}max \\ 1 DiDN\end{matrix} [ {δ}_{T} ( i ) ] , {a}_{T}^{*} = \begin{matrix}arg max \\ 1 DiDN\end{matrix} [ {δ}_{T} ( i ) ]$ |
| \hat{4} State Sequence Backtracking: | ${q}_{t}^{*} = {ψ}_{t + 1} ( {q}_{t + 1}^{*} ) , t = T - 1 , T - 2 , … , 1$ |

In the above algorithm, ψₜ(i) is a variable for maintaining the optimal path for transition to state i at time t. ψₜ(i) calculates the state path with the maximum probability by the equation

$${ψ}_{t} ( i ) = \begin{matrix}arg max \\ 1 DiDN\end{matrix} [ {δ}_{t - 1} ( i ) {a}_{ij} ] ,$$

using the most likely path δₜ₋₁ to the previous state (t−1) and the transition matrix to state j at time t.

In FIG. 9, δₜ(j) shows the probability of the most likely path among paths ending in state j and can be denoted by equation 3.

$${δ}_{t} ( i ) = {max}_{{q}_{1} , {q}_{2} , … , {q}_{t - 1}} P ( {q}_{1} , {q}_{2} , … , {q}_{t} , = i , {o}_{1} , {o}_{2} , … , {o}_{t} \vert λ ) \qquad [ Equation 3 ]$$

Equation 4 can be derived from equation 3 by induction.

$${δ}_{t + 1} ( j ) = {max}_{i} [ {δ}_{t} {a}_{ij} ] Eb ( {o}_{t + 1} ) \qquad [ Equation 4 ]$$

Equation 4 enables to obtain the state sequence with the maximum probability at time t+1, as well as at time t.

2. The Baum-Welch Algorithm

It is required to first select a model that best matches an observation sequence and set the optimal sequence of states within the model. It is then required to determine parameters of the model λ=(π, A, B), which maximize P(o|λ) with respect to the observation sequence o. Because of the complexity of models, it is difficult to determine the model parameters by an analytic method. Therefore, the Baum-Welch algorithm is used for parameter reestimation (training).

The Baum-Welch algorithm forms an initial model λ₀ and a new model λ based on the initial model and the observation sequence o. The Baum-Welch algorithm generates a new model by modifying the model parameters until the difference between the probability of a new model and that of the previous model is over a “predetermined value”.

The Baum-Welch algorithm additionally defines two new parameters according to equations 5 and 6.

$$ξ ( i , j ) = \frac{{α}_{1} ( i ) {a}_{ij} {b}_{j} ( {o}_{t + 1} ) {β}_{t + 1} ( j )}{P ( o \vert λ )} \qquad [ Equation 5 ]$$

Equation 5 shows the probability of being in state i at time t and state j at time t+1. In this equation, α is a forward parameter of the forward algorithm, and β is a backward parameter of the backward algorithm. If

$${{Q}^{T - 1}}_{t = 1} ξ ( i , j )$$

is applied to equation 5, an expected value of the number of transitions from state i to state j at the observation sequence o can be obtained.

$${γ}_{t} ( i ) = {{Q}^{N}}_{j = 1} {ξ}_{t} ( i , j ) \qquad [ Equation 6 ]$$

Equation 6 shows the probability of being in state i with the given observation sequence at time t. If

$${{Q}^{T}}_{t = 1} {γ}_{t} ( i )$$

is applied to equation 6, it is possible to obtain an expected value of the number of emissions at state i at the observation sequence o.

Through the methods mentioned above, the HMM classifier 840 selects music signals among inputted audio signals and outputs the selected signals to the DSP 210.

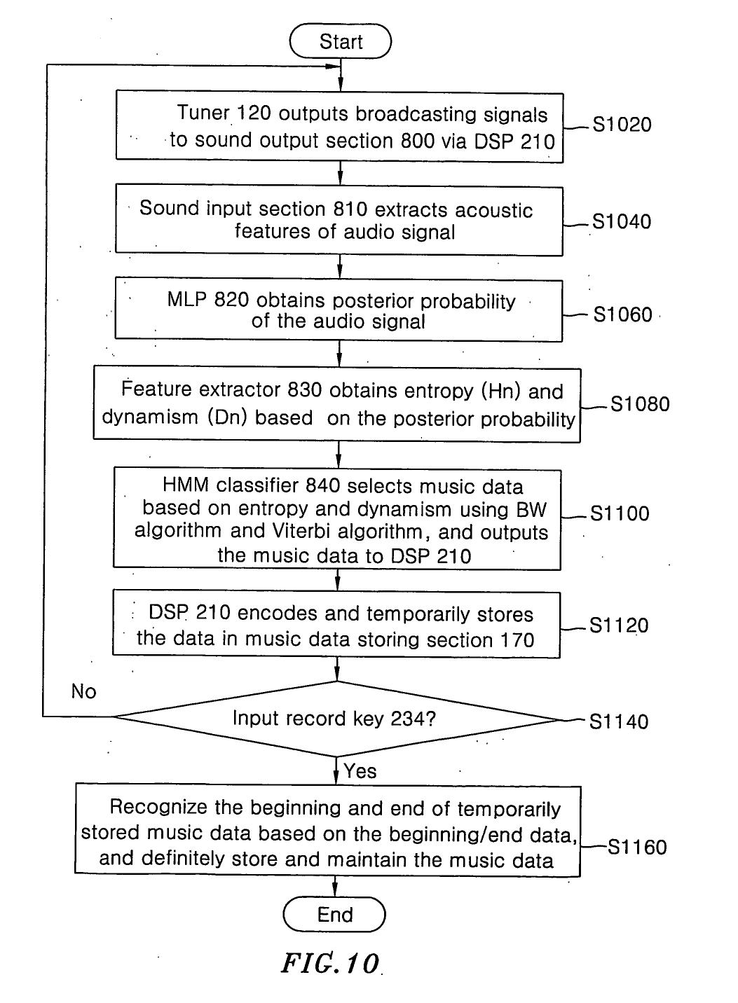

Hereinafter, the operation of the digital recorder, which outputs only music signals using the music extracting section 800, will be explained in more detail with reference to FIG. 10.

FIG. 10 is a flow chart showing a process of selectively storing music utilizing an HMM according to the third embodiment of the present invention.

When a broadcasting signal received by the antenna 110 is sent to the tuner 120, the tuner 120 outputs the signal to the sound output section 130. At the same time, the tuner 120 outputs the signal to the music extracting section 800 via the DSP 210 (S1020). The broadcasting signal inputted to the music extracting section 800 is sent to the sound input section 810. The sound input section 810 divides an audio signal into frames and extracts the acoustic features of the audio signal, for example, zero-crossing information, energy, pitch, spectral frequency and cepstral coefficient. The sound input section 810 sends the extracted acoustic features to the MLP 820 (S1040).

The MLP 820 obtains a posterior probability showing the possibility (probability P) as to the phoneme to which the acoustic features received from the sound input section 810 belong, and outputs the posterior probability to the feature extractor 830 (S1060). The feature extractor 830 obtains the entropy Hn and dynamism Dn features based on the posterior probability received from the MLP 820 (S1080). The feature extractor 830 outputs the obtained entropy Hn and dynamism Dn to the HMM classifier 840. The HMM classifier 840 selects only music data based on the entropy Hn and dynamism Dn received from the feature extractor 830, utilizing the Baum-Welch algorithm and the Viterbi algorithm. The HMM classifier 840 outputs the selected music data to the DSP 210 (S1100).

The DSP 210 encodes the music data received from the HMM classifier 840 into an MP3 music file, using the encoder 214, and temporarily stores the encoded data in the temporary storage area of the music data storing section 170 (S1120). At the same time, the DSP 210 outputs the broadcasting signals, including the music signal which is being temporarily stored, to the sound output section 130. When music, to which the user is listening, is temporarily stored in the temporary storage area of the music data storing section 170, the beginning and end of the music are recognized by the process as explained in the second embodiment. In this regard, the microprocessor 240, instead of the music extracting section 220, 500, 800, can be configured to have a function to recognize the beginning of a music signal.

If the record key 234 provided in the key input section 230 is pressed while broadcasting signals including a music signal are being outputted to the sound output section 130, the microprocessor 240 will control the DSP 210 to recognize the beginning and end points of the music data temporarily stored in the temporary storage area based on the beginning/end data stored in the non-music storage area of the music data storing section 170. The microprocessor 240 will then transfer the music data to the definite storage area in order to definitely store the music data (S1160). The meaning of “definitely store and maintain” is as explained in the second embodiment.

If the user does not press the record key 234, the microprocessor 240 will return to step S1020 and will repeat the process of outputting the broadcasting signals to the sound output section 130 and storing only music signals among the currently outputted broadcasting signals. The user can select and reproduce desired music from the music data stored in the music data storing section 170.

According to the third embodiment of the present invention, the digital recorder 200, includes the music extracting section 500 utilizing the HMM in order to classify broadcasting signals into speech signals and music signals and store the music signals only.

Although preferred embodiments of the present invention have been described for illustrative purposes, those skilled in the art will appreciate that various modifications, additions and substitutions are possible, without departing from the scope and spirit of the invention as disclosed in the accompanying claims.

It is possible to form a music extracting section utilizing an ICA (independent component analysis) based on speech recognition technology. Generally, “speech recognition” is a technique for recognizing or identifying human voice by a mechanical (computer) analysis. Human speech sounds have peculiar frequencies depending on the shape of mouth and the position of tongue which change according to the pronunciation. Human speech signals can be recognized by converting pronounced speech to an electrical signal and extracting a variety of features of a speech signal. Therefore, it is possible to extract and remove speech signals from broadcasting signals using a music extracting section based on the speech recognition technology, thereby outputting music signals only.

In the preferred embodiments of the present invention, the music data storing section 170 temporarily stores music data. Only when the record key 234 is pressed, the music data storing section 170 definitely stores and maintains the music data. However, it is also possible to provide a temporary memory to temporarily store one or more music data extracted by the music extracting section 220. Music data being outputted to the sound output section 130 and extracted by the music extracting section 220 can be stored in the temporary memory. When the record key 234 is pressed, the music data stored in the temporary memory can be transferred to the music data storing section 170 to be definitely stored. When the record key 234 is not pressed, the music data stored in the temporary memory can be deleted so that new music data can be stored in the temporary memory.

As described above, the present invention provides a digital recorder and a method for not only outputting received broadcasting signals as an audible sound, but also selectively storing music signals included in the broadcasting signals as digital music data, utilizing an artificial neural network, a frequency analysis or a hidden Markov model.

The digital recorder separates music from the received broadcasting signals and recognizes the beginning and end of the music to completely store the music from beginning to end. Accordingly, it is possible to record and reproduce music from the beginning thereof, even in case when a user starts to record the music after some lapse of time.

The present invention can solve inconvenience and trouble to press the record key twice to record music when begins and finish the recording operation when the music ends. Also, the present invention eliminates the need to pay close attention to correctly recognize the beginning and end of a musical selection.

1-35. (canceled)

36. A digital recorder which comprises a tuner for receiving and selecting a broadcasting signal, a sound output section for outputting a selected broadcasting signal as an audible sound, a music data storing section comprising a temporary storage area for temporarily including music data and a definite storage area for definitely storing music data, and a display section for displaying an operational state of the digital recorder, improvements of which comprise:
a signal processing section for converting the broadcasting signal into digital data or digital data into an analog signal, compressing and encoding digital data into music data, or decoding and outputting compressed digital data;
a music extracting section for dividing digital data outputted from the signal processing section into music data and non-music data according to a music extracting algorithm to extract only the music data, and generating and outputting beginning/end data for recognizing the beginning and end of extracted music data;
a key input section provided with a broadcast key for converting an operation mode of the digital recorder into a radio broadcast receiving mode and a record key for implementing a function to record and store a music signal broadcasted on radio; and
a microprocessor for controlling the signal processing section to temporarily store only the music data extracted by the music extracting section in the temporary storage area of the music data storing section, transferring the music data temporarily stored in the temporary storage area to a definite storage area when the record key is pressed, and definitely storing and maintaining the music data in the definite storage area.

37. The digital recorder according to claim 36, wherein said music extracting section implements an operation on a plurality of input data using an artificial neural network to divide the input data into the music data and the non-music data and removes the non-music data to extract only the music data.

38. The digital recorder according to claim 36, wherein said temporary storage area of the music data storing section continuously stores the music data in the order they are received, and if the music data exceed the storage capacity of the music data storing section, deletes the stored music data one by one in the order they were stored so as to store new music data.

39. The digital recorder according to claim 36, wherein said key input section comprises a delete key for deleting the music data, and said microprocessor outputs a list of music data stored in said music data storing section to said display section so that the user can select music data to be deleted from a list and delete the selected music data by pressing said delete key.

40. The digital recorder according to claim 36, wherein said signal processing section comprises:
an ADC (analog to digital converter) for converting an analog signal into a digital signal;
a DSP core for controlling the overall operation of the DSP;
a DAC (digital to analog converter) for converting a digital signal into an analog signal;
an encoder for compressing and encoding an analog signal, for example, into MP3 file data;
a DSP program section storing a program for converting a broadcasting signal received from a tuner into digital data according to a control command from the microprocessor, compressing and encoding the digital data, and decoding and outputting the compressed digital data; and
a decoder for decoding the compressed digital data.

41. The digital recorder according to claim 36, wherein said music extracting section includes:
an acoustic data operator section for implementing operations on left channel data and right channel data of the broadcasting data received from said signal processing section and outputting data on the operation results;
a non-music removing section for determining the broadcasting data to be mono data when the operation results received from said acoustic data operation section are near zero, or to be stereo data when the operation results show that a value greater than a critical value lasts for a certain period of time, and outputting only the stereo data by removing the mono data;
a music beginning/end determining section for outputting the stereo music data received from said non-music removing section to said signal processing section, generating beginning/end data for discriminating and recognizing the beginning and end points of said music data, and transferring the beginning/end data to said microprocessor; and
an a spectrum analysis section for performing a spectrum analysis on the music data received from said music beginning/end determining section to discriminate between the beginning and ending signals of music and generating beginning/end data for recognizing the beginning and ending signals.

42. The digital recorder according to claim 41, wherein said music beginning/end determining section detects the fade-out in the ending part of each music data, thereby recognizing the beginning and end of the music data.

43. The digital recorder according to claim 41, wherein said music beginning/end determining section recognizes the point of a mute as the beginning of music data and the point when new music data follows the mute as the end of the previous music data, and generates beginning/end data based on such determination.

44. The digital recorder according to claim 41, wherein said music beginning/end determining section calculates an energy variation of music data, recognizes a lower energy point as a mute or a probable ending point of the music data, and obtains an energy value by squaring the phase value of the music data in frames, which is received from the non-music removing section, and taking the log of the squared value, and said music beginning/end determining section detects and determines the beginning and end points of the music data, taking into account that the average length of music is three to five minutes.

45. The digital recorder according to claim 41, wherein said music beginning/end determining section sends the music data to the spectrum analysis section, when it fails to discriminate the beginning part of new music data from the end part of previous music data because there is no mute between the two music data or there is an overlapping part between the two music data.

46. The digital recorder according to claim 36, wherein said music extracting section collects data for extracting speech characteristics and utilizes a hidden Markov model (HMM) trained for such data to extract and remove hidden speech information from mixed sound information.

47. The digital recorder according to claim 46, wherein said music extracting section extracts acoustic signals and their features utilizing the Baum-Welch algorithm for the estimation of parameters of an HMM and extracts only music signals utilizing the Viterbi algorithm.

48. The digital recorder according to claim 46, wherein said music extracting section includes:
a sound input section for inputting an audio signal including a plurality of acoustic signals, among broadcasting signals received from said tuner, and extracting the acoustic features of the audio signal;
an MLP (multi-layer perceptron) for obtaining a posterior probability showing the possibility (probability P) as to which phoneme the acoustic features received from the sound input section belong to;
a feature extractor for implementing an operation based on the posterior probability received from the MLP to obtain an entropy Hn which shows a probability distribution within a frame and a dynamism Dn which is a probability of a variation between frames; and
an HMM classifier for classifying audio signals into a speech class and a music class based on the entropy Hn and dynamism Dn received from the feature extractor, utilizing the Baum-Welch algorithm and the Viterbi algorithm, and outputting music data only.

49. The digital recorder according to claim 48, wherein said acoustic features include zero-crossing information, energy, pitch, spectral frequency and cepstral coefficient.

50. The digital recorder according to claim 36, wherein said music extracting section extracts and removes speech signals from broadcasting signals utilizing an ICA (independent component analysis) based on speech recognition technology, thereby outputting music signals only.

51. A method for selectively storing music by using a digital recorder comprising: a tuner for receiving and selecting a broadcasting signal; a sound output section for outputting a selected broadcasting signal as an audible sound; a digital signal processor (DSP) for converting a broadcasting signal into digital data or digital data into an analog signal, compressing and encoding digital data into music data, or decoding and outputting compressed digital data; a music extracting section for extracting only music data from the digital data received from the DSP; a music data storing section for storing music data; a display section for displaying the operational state of the digital recorder; and a key input section for converting the operation mode of the digital recorder into a radio broadcast receiving mode and inputting a command to implement the recording of a music signal broadcasted on radio, said method comprising the steps of:
(a) said tuner's outputting a broadcasting signal to the sound output section and sending the signal to the DSP;
(b) said DSP's converting the broadcasting signal into digital data and outputting the data to the music extracting section;
(c) said music extracting section's extracting music data from the digital data according to a music extracting algorithm;
(d) recognizing the beginning and end of the extracted music data and temporarily storing the data in the music data storing section;
(e) determining whether a command to record music, which is being currently outputted to the sound output section, is inputted from the key input section; and
(f) definitely storing and maintaining the music data which is temporarily stored in the music data storing section.

52. The method according to claim 51, wherein said music extracting algorithm in step (c) implements an operation on a plurality of input data using an artificial neural network to divide the input data into music data and non-music data and removes the non-music data to extract only the music data.

53. The method according to claim 51, wherein said music extracting algorithm in step (c) collects data for extracting speech characteristics and utilizes a hidden Markov model (HMM) trained for such data to extract and remove hidden speech information from mixed sound information.

54. The method according to claim 51, wherein said music extracting algorithm in step (c) extracts and removes speech signals from broadcasting signals utilizing an ICA (independent component analysis) based on speech recognition technology, thereby outputting music signals only.

55. The method according to claim 51, wherein step (d) continuously stores music data in said music data storing section in the order they are received, and if the music data exceed the storage capacity of said music data storing section, said DSP deletes the stored music data one by one in the order they were stored in order to store new music data.

56. The method according to claim 51, wherein said step (d) recognizes the point of a mute as the beginning of music data and the point when new music data follows the mute as the end of the previous music data.

57. The method according to claim 51, wherein said step (d) detects the fade-out in the ending part of each music data, thereby recognizing the beginning and end of the music data.

58. The method according to claim 51, wherein said step (d) calculates an energy variation of music data, recognizes a lower energy point as a mute or a probable ending point of the music data, and obtains an energy value by squaring the phase value of the music data in frames, which is received from the non-music removing section, and taking the log of the squared value, and said step (d) detects and determines the beginning and end points of the music data, taking into account that the average length of music is three to five minutes.

59. A method for selectively storing music using a digital recorder comprising: a tuner for receiving and selecting broadcasting signals; a signal processing section for converting the broadcasting signals into digital data, and compressing and encoding digital data into music data; a music extracting section for extracting only music data from the broadcasting signals; and a memory for storing the extracted music data, said method comprising the steps of:
(a) sending the broadcasting signals outputted from said tuner to said sound output section;
(b) said music extracting section's recognizing the beginning of music included in the broadcasting signals according to a music extracting algorithm;
(c) temporarily storing the recognized music data in a temporary storage area of said memory;
(d) determining whether there is an input of a command to record the music data while being stored in said music data storing section; and
(e) when a command to record the music data is inputted, transferring the temporarily stored music data to a definite storage of said memory to definitely store and maintain the music data.

60. The method according to claim 59, wherein said music extracting algorithm in step (b) collects data for extracting speech characteristics and utilizes a hidden Markov model (HMM) trained for such data to extract and remove hidden speech information from mixed sound information.

61. The method according to claim 59, wherein said music extracting algorithm in step (b) implements an operation on a plurality of input data using an artificial neural network to divide the input data into music data and non-music data and removes the non-music data to extract only the music data

62. The method according to claim 59, wherein said music extracting algorithm in step (b) extracts and removes speech signals from broadcasting signals utilizing an ICA (independent component analysis) based on speech recognition technology, thereby outputting music signals only.

63. The method according to claim 59, wherein said step (e) returns to step (b) to recognize following music, if a record command is not inputted.
